(19) United States
(12) Patent Application Publication
(10) Pub. No.: US 2013/0163616 A1
(43) Pub. Date: Jun. 27, 2013

(54) COMMUNICATION APPARATUS THAT CAN BE OPERATED IN POWER-SAVING MODE, METHOD OF CONTROLLING THE APPARATUS, AND STORAGE MEDIUM

(71) Applicant: CANON KABUSHIKI KAISHA, TOKYO (JP)

(72) Inventor: HIROAKI NIITSUMA, YOKOHAMA-SHI (JP)

(73) Assignee: CANON KABUSHIKI KAISHA, TOKYO (JP)

(21) Appl. No.: 13/719,330

(22) Filed: Dec. 19, 2012

(30) Foreign Application Priority Data
Dec. 27, 2011 (JP) 2011-285963

(51) Int. Cl. H04L 12/12

(52) U.S. Cl. CPC H04L 12/12
USPC 370/468

(57) ABSTRACT

A communication apparatus which makes it possible to achieve the securing of network communication speed and the reduction of power consumption of a communication apparatus at the same time. The communication apparatus performs communication at a first link speed when operating in a power-saving mode and at a second link speed higher than the first link speed when operating in a normal power mode. In a first link unit, a standby time period for switching the first link speed to the second link speed is required after the communication apparatus enters the normal power mode. In a second link unit, the standby time period is not required. When a predetermined condition is satisfied, the communication apparatus switches between a communication by the first link unit and a communication by the second link unit such that one of the communications which consumes less electric power is selected, based on switching information.

### BACKGROUND OF THE INVENTION

1. Field of the Invention

The present invention relates to a communication apparatus, a method of controlling the same, and a storage medium.

2. Description of the Related Art

In recent years, with development and widespread use of network techniques, an increasing number of image processing apparatuses come to be equipped with a function for connecting to a network as standard.

For example, an image processing apparatus, such as a printing apparatus or a copying machine, which is equipped with the network function, is capable of receiving data and commands from an external device, such as a personal computer, via a network, and performing data processing and print processing.

Further, with enhancement of awareness about environmental problems, in the technical field concerning the image processing apparatus equipped with the network function, there is an increasing demand for reduction of power consumption by the apparatus when in a non-operating state.

To meet the demand, there has been proposed a technique for realizing a power-saving mode in which when an image processing apparatus is in a non-operating state, the supply of power to a main controller that controls the image processing apparatus is reduced than usual or cut off so as to reduce power consumption of the image processing apparatus.

Network link speed is related to power consumption. The higher the network link speed is, the larger the power consumption is, and the lower the network link speed is, the smaller the power consumption is.

For example, there has been disclosed a technique in which when an apparatus is in a communication standby state, communication speed is switched to a low-speed mode, and when the apparatus receives a communication request from another network apparatus, communication is performed with the currently set communication speed maintained. In this technique, the communication speed is switched to a high-speed mode after completion of the communication (see e.g. Japanese Patent Laid-Open Publication No. 2010-171792).

However, in the technique disclosed in Japanese Patent Laid-Open Publication No. 2010-171792, the apparatus performs communication in the low-speed mode in response to a communication request received in the communication standby state, so that it is impossible to perform high-speed network communication for the request.

Even if the apparatus changes the network link speed to the high-speed mode so as to solve the above-mentioned problem, communication cannot be performed until a link is established, which makes it impossible to provide quick network response.

Further, when the image processing apparatus on standby for communication receives a communication request, and in response to the communication request, the image processing apparatus transitions from the power-saving mode to a normal operation mode, the power supply to the main controller that controls the image processing apparatus is caused to return to a normal supply state.

Therefore, the image processing apparatus continues to be inoperative while remaining in a high power consumption state until the network link speed is changed and a link is established, which causes wasteful consumption of power.

### SUMMARY OF THE INVENTION

The present invention makes it possible to achieve the securing of network communication speed and the reduction of power consumption of a communication apparatus at the same time.

In a first aspect of the present invention, there is provided a communication apparatus comprising a control unit configured to control the communication apparatus, a communication unit configured to communicate with an external device via a network, a power supply unit configured to, in a normal power state, supply power to the control unit and the communication unit, and in a power saving state, supply power to the communication unit, but not supply power to the control unit, and a determination unit configured to determine in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate, wherein the determination unit determines in which of the first communication mode and the second communication mode the communication apparatus is to be caused to operate, based on the number of times of transition between the normal power state and the power saving state.

In a second aspect of the present invention, there is provided a method of controlling a communication apparatus including a control unit configured to control the communication apparatus, and a communication unit configured to communicate with an external device via a network, comprising supplying, in a normal power state, power to the control unit and the communication unit, and in a power saving state, supplying power to the communication unit, but not supplying power to the control unit, and determining in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate, based on the number of times of transition between the normal power state and the power saving state.

In a third aspect of the present invention, there is provided a non-transitory computer-readable storage medium storing a computer-executable program for causing a computer to execute a method of controlling a communication apparatus including a control unit configured to control the communication apparatus, and a communication unit configured to communicate with an external device via a network, wherein the method comprises supplying, in a normal power state, power to the control unit and the communication unit, and in a power saving state, supplying power to the communication unit, but not supplying power to the control unit, and determining in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate, based on the number of times of transition between the normal power state and the power saving state.

According to the present invention, it is possible to achieve the securing of network communication speed and the reduction of power consumption of the communication apparatus at the same time.

Further features of the present invention will become apparent from the following description of an exemplary embodiment with reference to the attached drawings.

### BRIEF DESCRIPTION OF THE DRAWINGS

FIG. 1 is a block diagram schematically showing the configuration of an image processing apparatus according to an embodiment of the present invention and a whole system including the image processing apparatus.

FIG. 2 is a detailed block diagram of the image processing apparatus according to the embodiment.

FIG. 3 is a block diagram of a LAN interface appearing in FIG. 2.

FIGS. 4A and 4B are diagrams useful in explaining power modes of the image processing apparatus in FIG. 1 and power consumption associated with a network link state of the LAN interface.

FIG. 5 is a flowchart of a link speed change control process executed by a CPU appearing in FIG. 2.

FIG. 6 is a flowchart of a link establishment standby period determination process executed by the CPU appearing in FIG. 2.

FIG. 7 is a flowchart of a variation of the link speed change control process executed by the CPU appearing in FIG. 2.

### DESCRIPTION OF THE EMBODIMENTS

The present invention will now be described in detail below with reference to the accompanying drawings showing an embodiment thereof.

In the present embodiment, a communication apparatus according to the present invention is applied to an image processing apparatus.

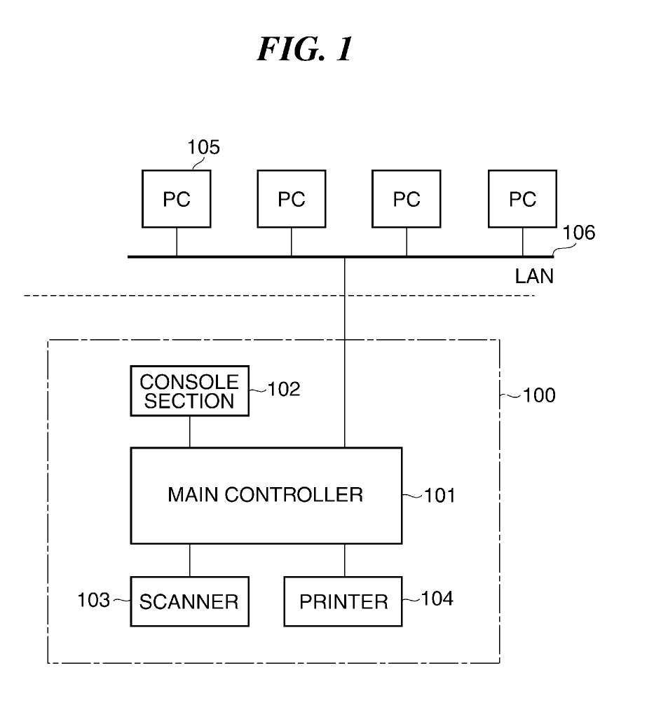

FIG. 1 is a block diagram schematically showing the configuration of the image processing apparatus 100 according to the embodiment and a whole system including the image processing apparatus 100.

Referring to FIG. 1, the image processing apparatus 100 performs image input and output, image transmission and reception, and various kinds of image processing. The image processing apparatus 100 includes a main controller 101, a console section 102 as a user interface, a scanner 103 as an image input device, and a printer 104 as an image output device.

Each of the console section 102, the scanner 103, and the printer 104 is connected to the main controller 101 and is controlled by instructions from the same. Further, the main controller 101 is connected to a LAN (local area network) 106 whereby it is connected e.g. to PCs 105 connected to the LAN 106.

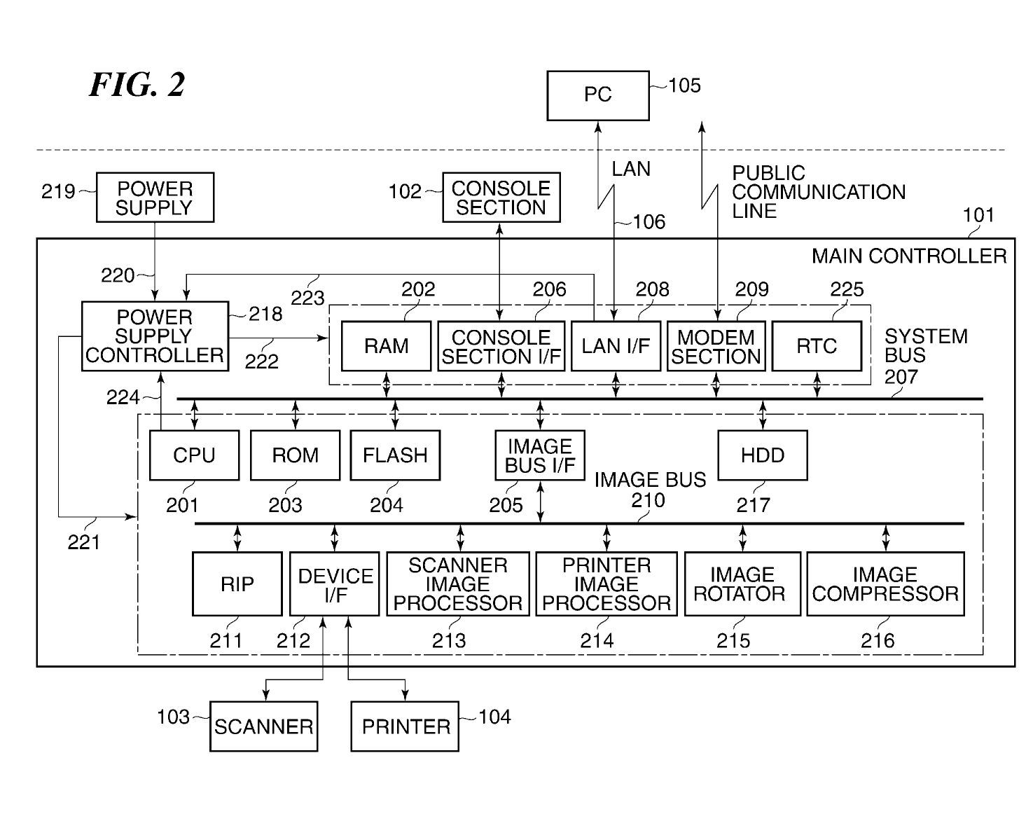

FIG. 2 is a detailed block diagram of the image processing apparatus 100 according to the embodiment.

Referring to FIG. 2, the image processing apparatus 100 includes the main controller 101 that controls the overall operation of the apparatus. The main controller 101 controls the scanner 103 and the printer 104. Further, the main controller 101 is connected to the LAN 106 and a public communication line to input and output image information, device information, files, etc. from and to external devices.

The main controller 101 includes a CPU (central processing unit) 201 as a main control unit. The CPU 201 is connected to a RAM (random access memory) 202, a ROM (read only memory) 203, and a flash memory 204. Further, the CPU 201 is connected to an image bus interface 205, a console section interface 206, a LAN interface 208, a modem section 209, and a RTC (real time clock) 225.

The RAM 202 is a readable/writable memory which provides a work area for the CPU 201. The RAM 202 is also used as an image memory for temporarily storing image data.

The ROM 203 is a boot ROM that stores a boot program for the system. The flash memory 204 is a nonvolatile memory that stores system software, setting data, etc. required to be held even after the power of the image processing apparatus 100 is turned off.

The console section interface 206 provides interface for inputting and outputting data to and from the console section 102. The console section interface 206 is used to output image data to be displayed to the console section 102, and transfer information input by a user via the console section 102 to the CPU 201.

The LAN interface 208 provides interface for connection to the LAN 106. The LAN interface 208 is used to input and output information to and from the LAN 106. The modem section 209 provides interface for connection to the public communication line, and is used to input and output information via the public communication line. The RTC 225 manages the current time.

The image bus interface 205 provides interface for connection between a system bus 207 and an image bus 210 used for high-speed transfer of image data. The image bus interface 205 functions as a bus bridge for converting the data structure.

Connected to the image bus 210 are a RIP (raster image processor) 211, a device interface 212, a scanner image processor 213, a printer image processor 214, an image rotator 215, and an image compressor 216.

The RIP 211 expands PDL (page description language) data received from the LAN 106 into a bitmap image. The device interface 212 provides interface for connection between the scanner 103 and the printer section 104, and the main controller 101. The RIP 211 performs synchronous-to-asynchronous or asynchronous-to-synchronous conversion of image data.

The scanner image processor 213 corrects, processes, edits, or other processing on input image data read by the scanner 103. The printer image processor 214 performs color conversion, filtering, resolution conversion, or other processing on image data to be output to the printer 104.

The image rotator 215 rotates image data. The image compressor 216 performs JPEG compression and decompression on multi-valued image data, and JBIG, MMR, or MH-based compression and decompression on binary image data. A HDD (hard disk drive) 217 is a nonvolatile storage device that stores various kinds of data, such as image data, address book data, job log data, and user-specific data. Note that when the main controller 101 does not include the HDD 217, the above-mentioned kinds of data are stored in the flash memory 204.

A power supply controller 218 supplies DC power received from a power supply 219 via a power supply line 220 to predetermined circuit elements of the main controller 101 via power supply lines 221 and 222.

The power supply controller 218 controls power to be supplied via the power supply lines 221 and 222 based on a control signal received from the LAN interface 208 via a control signal line 223 and a control signal received from the CPU 201 via a control signal line 224.

The power supply line 221 is connected to the CPU 201, the ROM 203, the flash memory 204, the image bus interface 205, and the HDD 217. Further, the power supply line 221 is connected to the RIP 211, the device interface 212, the scanner image processor 213, the printer image processor 214, the image rotator 215, and the image compressor 216. The power supply line 222 is connected to the RAM 202, the console section interface 206, the LAN interface 208, the modem section 209, and the RTC 225.

The image processing apparatus 100 configured as above is provided with two power supply modes, i.e. a power-saving mode in which the power state of the apparatus is changed depending on an operating state thereof and a normal power mode in which more electric power is consumed than in the power-saving mode.

In both the normal power mode and the power-saving mode, the power supply 219 supplies power to the power supply controller 218 via the power supply line 220.

In the normal power mode, the CPU 201 controls the power supply controller 218 such that supply of power to the power supply line 221 and the power supply line 222 is enabled. As a consequence, in the normal power mode, electric power is supplied from the power supply 219 to both the CPU 201 and the LAN interface 208.

On the other hand, in the power-saving mode, the CPU 201 controls the power supply controller 218 such that supply of power to the power supply line 221 is disabled and supply of power to the power supply line 222 is enabled. At this time, power supply to the main circuit elements of the main controller 101 including the CPU 201 is cut off.

As a consequence, in the power-saving mode, it is possible to considerably reduce power consumption of the image processing apparatus 100 than in the normal power mode. Upon receipt of data concerning a print job or the like from a PC 105 on the LAN 106, the LAN interface 208 controls the power supply controller 218 to return the image processing apparatus 100 from the power-saving mode to the normal power mode.

In the power-saving mode, the power supply 219 supplies power to the RAM 202, and therefore the RAM 202 is brought into a low power consumption state while backing up a system program by self-refresh operation.

Further, data can be input and output to and from the RAM 202 via the LAN interface 208 by DMA transfer using a DMA (direct memory access) controller, not shown, provided in the LAN interface 208.

Although in the above description, power supply to the CPU 201 is cut off in the power-saving mode, this is not limitative. For example, the power-saving mode may be a state of the operating frequency of the CPU 201 being lowered by reducing power supply to the CPU 201 than in the normal power mode.

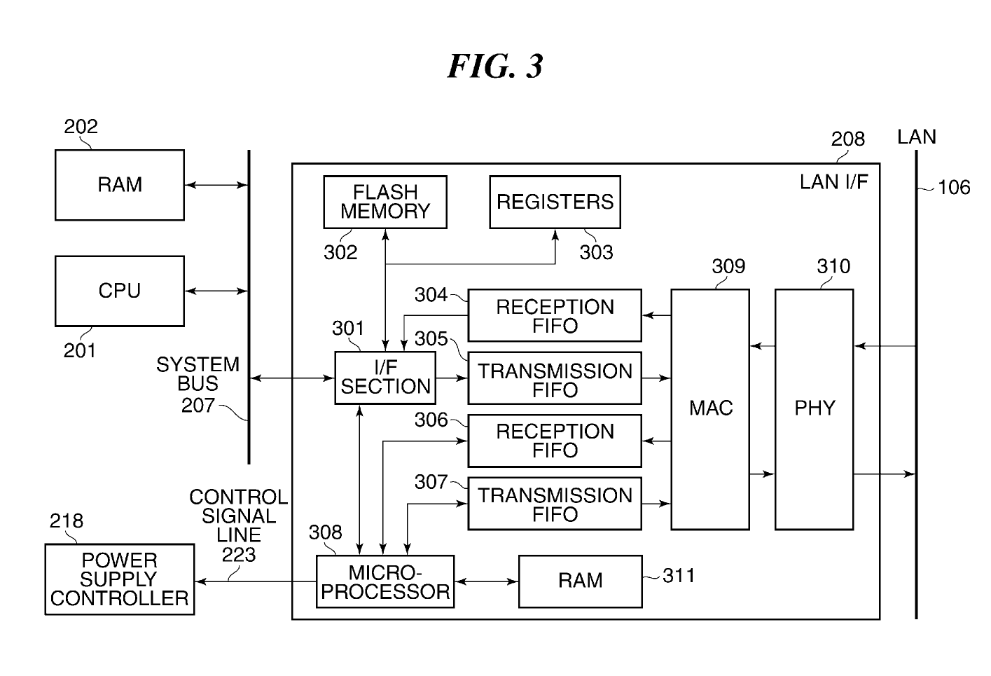

FIG. 3 is a block diagram of the LAN interface 208 appearing in FIG. 2.

Referring to FIG. 3, a RAM 311 is a shared memory area in the LAN interface 208. The RAM 311 stores data and a program necessitated for a packet response process executed by the LAN interface 208.

A flash memory 302 is a nonvolatile memory that stores e.g. firmware necessitated for the operation of a microprocessor 308, which has been received from the outside of the LAN interface 208 via an interface section 301.

Registers 303 form a register group for storing e.g. operation setting information and status information on the LAN interface 208. Further, in the present embodiment, at least one of a MAC (media access control device, also called “link layer device”) 309 and a PHY (physical layer device) 310 is compatible with the EEE (Energy Efficient Ethernet (registered trademark)).

The microprocessor 308 sets the MAC 309 and the PHY 310 to an EEE mode, whereby dynamic power control according to a communication condition on the network can be performed. For example, when the MAC 309 and the PHY 310 are set to a 1 Gbps EEE mode (1G-EEE), it is possible to considerably reduce power consumption than in the conventional 1 Gbps connection in a non-communication state, without being required to set the apparatus to a lower-speed mode.

Next, a description will be given of a packet receiving operation in the normal power mode. In the normal power mode, the image processing apparatus 100 is connected to the LAN 106 with the network link speed set to a link speed of e.g. 1 Gbps, which is the highest speed available in the network environment, so as to perform high-speed network communication.

The image processing apparatus 100 receives a packet from the LAN 106 via the PHY 310. The PHY 310 performs protocol control in the physical layer of the network to convert an electric signal received from the LAN 106 to a logical signal. The PHY 310 transfers the received packet to the MAC 309.

The MAC 309 detects the destination of the data, the sender of the same, and the boundary of frames as transmission/reception units from the logical signal received from the PHY 310. The MAC 309 transfers each received packet to a reception FIFO (first in first out) 304 as a reception buffer. Then, the received packet is passed into the main controller 101 via the interface section 301 connected to the system bus 207.

Next, a description will be given of a packet transmitting operation in the normal power mode. The packet transmitting operation is performed in the procedure reverse to that of the above-described packet receiving operation. Specifically, within the main controller 101, packets for transmission are buffered in a transmission FIFO 305 as a transmission buffer via the interface section 301. Thereafter, the MAC 309 transfers each packet for transmission from the transmission FIFO 305 to the PHY 310. Then, the packet for transmission is output to the LAN 106.

Next, a description will be given of a packet receiving operation in the power-saving mode. In the power-saving mode, the image processing apparatus 100 is connected to the LAN 106 with the network link speed set to a link speed of e.g. 10 Mbps, which is the lowest speed, so as to reduce power consumption.

The image processing apparatus 100 receives packets from the LAN 106 via the PHY 310. The PHY 310 transfers each received packet to the MAC 309. The MAC 309 transfers the received packet to a reception FIFO 306 as a reception buffer.

Upon detecting that the reception FIFO 306 has buffered the received packet, the microprocessor 308 analyzes the received packet and determines whether or not it is possible to respond to the packet while continuing to maintain the power-saving mode.

Specifically, the microprocessor 308 compares a destination address, a protocol type, etc. obtained by analyzing the header and payload of the received packet with corresponding elements in each of responsible patterns stored in advance in the RAM 311, to thereby determine whether or not it is possible to respond to the packet, i.e. whether or not it is possible to employ any of the responsible patterns.

The responsible patterns include responses using protocols, such as ARP (address resolution protocol) and SNMP (simple network management protocol). When it is possible to respond while continuing to maintain the power-saving mode, the microprocessor 308 generates a response packet according to the received packet.

Specifically, the microprocessor 308 generates a response packet including header information and payload information, based on the above-mentioned result of the analysis of the received packet and a responsible pattern which can be used. The microprocessor 308 sends the response packet to a transmission FIFO 307, and the response packet is transferred from the transmission FIFO 307 to the MAC 309. The MAC 309 transfers the response packet to the PHY 310, and then the response packet is output to the LAN 106.

On the other hand, when it is determined that it is impossible to respond while continuing to maintain the power-saving mode, the microprocessor 308 notifies the power supply controller 218 of shift to the normal power mode. Then, the main controller 101 returns to the normal power mode under the control of the power supply controller 218.

At this time, the image processing apparatus 100 is reconnected to the LAN 106 with the network link speed set to a link speed of e.g. 1 Gbps, which is the highest speed available in the network environment, so as to perform high-speed network communication. After a link to the network is established, the image processing apparatus 100 executes response processing for response to the received packet, using the main circuit elements including the CPU 201.

In the present embodiment, 10 Mbps corresponds to a first link speed, and 1 Gbps corresponds to a second link speed.

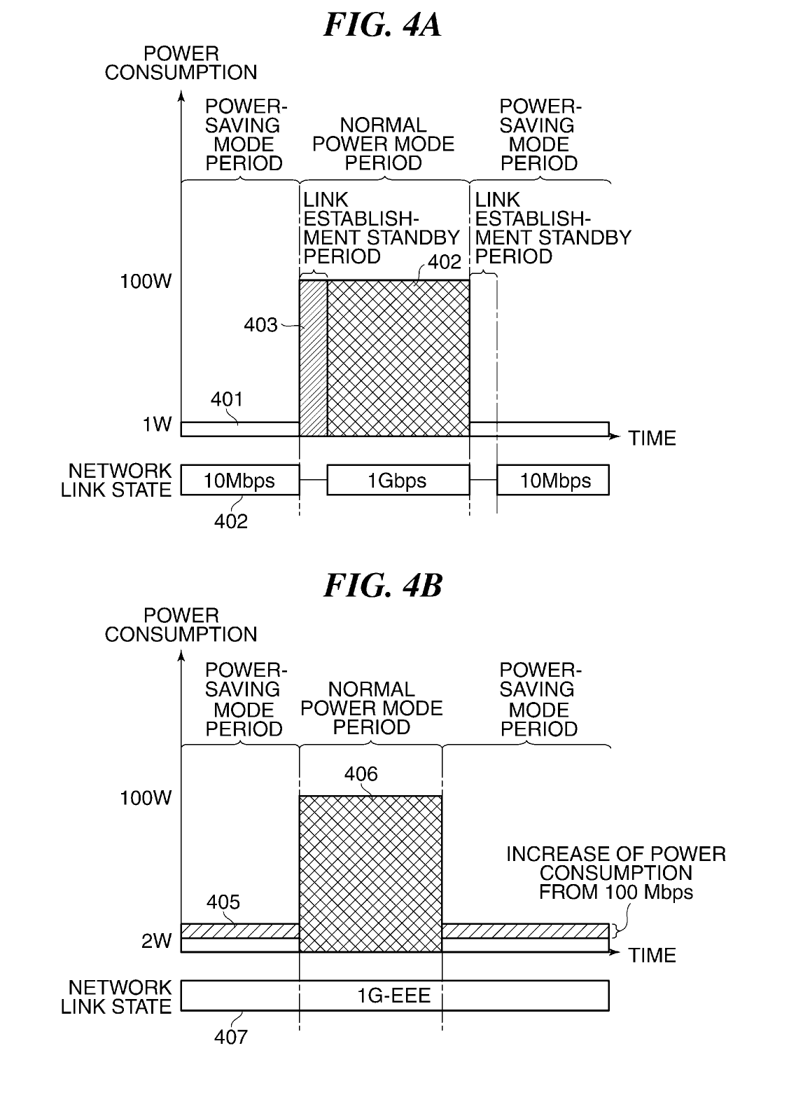

FIGS. 4A and 4B are diagrams useful in explaining the power modes of the image processing apparatus 100 in FIG. 1 and power consumption according to the network link state of the LAN interface 208. FIG. 4A shows the relationship between power consumption of the image processing apparatus 100 in the normal power mode and the power-saving mode and the network link state of the LAN interface 208. FIG. 4B shows the relationship between power consumption of the image processing apparatus 100 in the normal power mode and the power-saving mode and the network link state of the LAN interface 208 in a case where the MAC 309 and the PHY 310 are set to 1 G-EEE.

Referring to FIG. 4A, the vertical axis represents the power consumption of the image processing apparatus 100, and the horizontal axis represents elapsed time of the operating state of the image processing apparatus 100.

A rectangle denoted as a power-saving mode period 401 represents power consumption of the image processing apparatus 100 in the power-saving mode. In the present embodiment, the power consumption is 1 W. A rectangle denoted as a normal power mode period 402 represents power consumption of the image processing apparatus 100 in the normal power mode. In the present embodiment, the power consumption is 100 W.

A rectangle denoted as a link establishment standby period 403 represents a time period over which the image processing apparatus 100 has to wait until a link is established by switching between network link speeds, described hereinafter. The link establishment standby period 403 is included in the normal power mode period 402 in terms of the operating state of the image processing apparatus 100, and therefore the power consumption is 100 W.

A network link state 404 represents the network link state of the LAN interface 208.

As shown in FIG. 4A, in the power-saving mode, the image processing apparatus 100 is connected to the LAN 106 with the network link speed set to a low link speed of 10 Mbps so as to reduce power consumption.

Then, when the image processing apparatus 100 returns to the normal power mode, the image processing apparatus 100 is reconnected to the LAN 106 with the network link speed set to a link speed of e.g. 1 Gbps so as to perform high-speed network communication.

When the link speed is changed as described above, the image processing apparatus 100 has to wait over the link establishment standby period 403 until a link to the network is established.

In particular, electric power consumed in the link establishment standby period 403 over which the image processing apparatus 100 has to wait immediately after returning to the normal power mode is wasted because network processing is not executed by the image processing apparatus 100.

Referring to FIG. 4B, the vertical axis represents the power consumption of the image processing apparatus 100, and the horizontal axis represents elapsed time of the operating state of the image processing apparatus 100.

A rectangle denoted as a power-saving mode period 405 represents power consumption of the image processing apparatus 100 in the power-saving mode. The above-mentioned EEE mode is advantageous in that effective power control can be performed according to a communication condition without switching between the link speeds. However, when communication is not performed, the effect of reduction of power consumption in 1 G-EEE is lower than a power consumption reduction effect obtained by setting the link speed to 10 Mbps.

For this reason, electric power consumed when the MAC 309 and the PHY 310 is set to 1 G-EEE is slightly larger than electric power consumed when the MAC 309 and the PHY 310 is set to 10 Mbps. In the present embodiment, power consumption of the image processing apparatus 100 in the power-saving mode period 405 is 2 W.

A rectangle denoted as a normal power mode period 406 represents power consumption of the image processing apparatus 100 in the normal power mode. Electric power consumed in 1 G-EEE during communication is the same as when the link speed is set to 1 Gbps. Therefore, in the present embodiment, the power consumption of the image processing apparatus 100 in the normal power mode period 406 is 100 W as in the normal power mode period 402.

A network link state 407 represents the network link state of the LAN interface 208.

In FIG. 4B, the network link speed is maintained at the setting of 1 G-EEE but not changed according to power-mode transition of the image processing apparatus 100, and hence there is no time corresponding to the link establishment standby period 403 in FIG. 4A.

Consequently, in a case where the same network processing as executed when the apparatus returns to the normal power mode in FIG. 4A is executed, the normal power mode period 406 is shorter than the normal power mode period 402 by a time period corresponding to the link establishment standby period 403. Thus, in FIG. 4B, it is possible to avoid wasteful consumption of electric power corresponding in amount to electric power which is wasted during the link establishment standby period 403 in FIG. 4A.

Next, a description will be given of control for switching between the FIG. 4A state and the FIG. 4B state. The difference between the FIG. 4A state and the FIG. 4B state lies in the network link state. In the FIG. 4A state, the link speed of the LAN interface 208 is changed according to the power mode of the image processing apparatus 100.

On the other hand, in the FIG. 4B state, the link speed of the LAN interface 208 is maintained at the setting of 1 G-EEE irrespective of the power mode of the image processing apparatus 100.

The total power consumption of the image processing apparatus 100 in a predetermined time period changes depending on the operating state of the image processing apparatus 100, specifically the length of the link establishment standby period 403 and that of the power-saving mode period 401.

This means that by selecting one of the FIG. 4A state and the FIG. 4B state according to the frequency of network response performed by the image processing apparatus 100, it is possible to reduce the total power consumption of the image processing apparatus 100 in the predetermined time period.

The turning point for selection between the FIG. 4A state and the FIG. 4B state is determined based on the relationship between power consumption in the normal power mode x a link establishment standby period and an increase of power consumption in the 1 G-EEE mode from power consumption in 10 Mbps x a power-saving mode period.

The link establishment standby period 403 is unconditionally stored in advance in the ROM 203 of the main controller 101. In the present embodiment, assuming that the link establishment standby period 403 is e.g. 10 seconds, 1000 seconds (≠16.6 minutes) of the power-saving mode period is a turning point.

More specifically, if the power-saving mode period is maintained only for 16 minutes, the total power consumption of the image processing apparatus 100 in the predetermined time period can be reduced to a smaller amount by setting the link speed of the LAN interface 208 to 1 G-EEE.

On the other hand, if the power-saving mode period is maintained for 17 minutes or more, the total power consumption of the image processing apparatus 100 in the predetermined time period can be reduced to a smaller amount by setting the link speed of the LAN interface 208 to 10 Mbps and changing the same to 1 Gbps when the image processing apparatus 100 returns to the normal power mode.

The image processing apparatus 100 returns to the normal power mode when network response in the normal power mode is required after a packet is received from the LAN 106. The network response is executed after the LAN interface 208 establishes a link at 1 Gbps.

As described above, the image processing apparatus 100 according to the present embodiment performs communication at the link speed of 10 Mbps while operating in the power-saving mode, and performs communication at the link speed of 1 Gbps, which is higher than 10 Mbps, while operating in the normal power mode.

FIG. 4A shows that in the case of switching the power-saving mode to the normal power mode, the link establishment standby period for switching 10 Mbps to 1 Gbps is required after the image processing apparatus 100 enters the normal power mode. Thus, the processing for executing the link method illustrated in FIG. 4A corresponds to the function of a first link unit.

On the other hand, FIG. 4B shows that the amount of electric power consumed when communication is performed at 10 Mbps is larger than when communication is performed at 10 Mbps in FIG. 4A and that the standby period is not required for switching 10 Mbps to 1 Gbps. Thus, the processing for executing the link method illustrated in FIG. 4B corresponds to a second link unit.

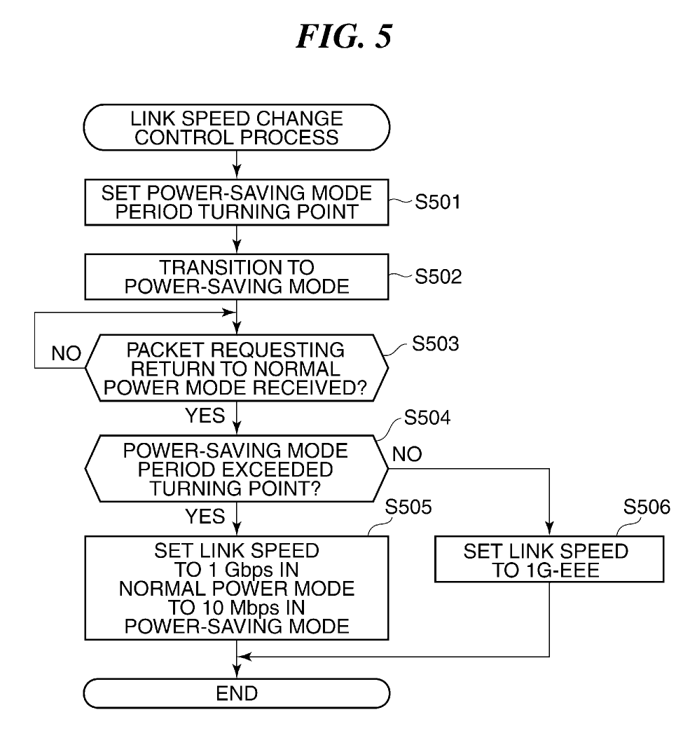

FIG. 5 is a flowchart of a link speed change control process executed by the CPU 201 appearing in FIG. 2.

The link speed change control process in FIG. 5 is realized by the CPU 201 of the main controller 101 controlling the LAN interface 208 according to a program stored in the ROM 203.

Referring to FIG. 5, the CPU 201 sets the power-saving mode period turning point for changing the link speed, based on power consumption information on the image processing apparatus 100 (step S501). The power consumption information is indicative of the power consumption of the image processing apparatus 100 in the normal power mode and that in the power-saving mode, and is stored in advance in the ROM 203.

In the present embodiment, the power consumption in the normal power mode is 100 W, and the power consumption in the power-saving mode is 1 W, as mentioned hereinabove by way of example. The power-saving mode period turning point is set by calculation based on the relationship between power consumption in the normal power mode x a link establishment standby period and an increase of power consumption in the 1 G-EEE mode from power consumption in 10 Mbps x a power-saving mode period.

Then, the CPU 201 sets the power-saving mode period turning point and then acquires a current time from the RTC 225 and stores the acquired time in the RAM 202, whereafter the image processing apparatus 100 transitions to the power-saving mode (step S502).

When the image processing apparatus 100 receives a packet from the LAN 106 while being on standby in the power-saving mode, the microprocessor 308 determines whether or not it is possible to respond while continuing to maintain the power-saving mode. More specifically, the microprocessor 308 determines whether or not a packet response to which requires return to the normal power mode has been received (step S503).

If it is determined in the step S503 that a packet response to which requires return to the normal power mode has been received (YES to the step S503), the microprocessor 308 determines whether or not the power-saving mode period has exceeded the turning point (step S504).

Specifically, the CPU 201 acquires a current time from the RTC 225 and calculates the power-saving mode period based on the acquired time and the time stored in the RAM 202. This power-saving mode period corresponds to a time period from a time point when the image processing apparatus 100 transitions to the power-saving mode in the step S502 to a time point when the image processing apparatus 100 returns to the normal power mode. The CPU 201 determines whether or not the calculated power-saving mode period has exceeded the above-mentioned power-saving mode period turning point.

If it is determined in the step S504 that the power-saving mode period has exceeded the turning point (YES to the step S504), the CPU 201 sets the network link speed of the LAN interface 208 to 1 Gbps in the normal power mode and to 10 Mbps in the power-saving mode as shown in FIG. 4A (step S505), followed by terminating the present process.

If it is determined in the step S504 that the power-saving mode period has not exceeded the turning point (NO to the step S504), the CPU 201 sets the network link speed of the LAN interface 208 to 1 G-EEE irrespective of the power mode of the image processing apparatus 100 as shown in FIG. 4B (step S506), followed by terminating the present process.

By executing the above-described link speed change control process, it is possible to reduce the power consumption of the image processing apparatus 100 according to the operating condition of the same and the network environment.

Although in the link speed change control process in FIG. 5, the link establishment standby period is fixedly set to 10 seconds by way of example, it may be dynamically determined according to the environment of the network to which the image processing apparatus 100 is connected, instead of fixedly setting the link establishment standby period.

By thus determining the network environment-dependent link establishment standby period based on the environment of the network to which the image processing apparatus 100 is connected, instead of unconditionally determining the same in advance, it is possible to achieve more effective reduction of power consumption according to the network environment.

Note that in the step S501, standby-period electric power consumed during a standby period, first electric power consumed during communication performed at 10 Mbps by the first link unit, and second electric power consumed during communication performed at 1 Gbps by the second link unit are used. Therefore, the above-described power-saving mode period turning point serves as a piece of switching information for switching between a communication by the first link unit and a communication by the second link unit such that one of the communications which consumes less electric power is selected. Since the step S501 sets this switching information, and hence it corresponds to the function of a setting unit.

Further, in the step S505 or S506, when a predetermined condition is satisfied, switching between a communication by the first link unit and a communication by the second link unit is performed using the set switching information such that one of the communications which consumes less electric power is selected. Therefore, the steps S505 and S506 correspond to the function of a switching unit.

The predetermined condition is that predetermined data requiring operation in the normal power mode has been received, and the switching information includes a time period (power-saving mode period) calculated based on the standby-period electric power, the first electric power, and the second electric power. The predetermined data requiring operation in the normal power mode is not data conforming to the above-mentioned protocol, such as ARP or SNMP, but data designating image formation, for example.

According to the link speed change control process shown in FIG. 5, the switching information is set for switching between a communication by the first link unit and a communication by the second link unit such that one of the communications which consumes less electric power is selected (step S501). Then, when the predetermined condition is satisfied, switching between the communication by the first link unit and the communication by the second link unit is performed using the set switching information such that one of the communications which consumes less electric power is selected (step S505 or S506). This makes it possible to achieve the securing of network communication speed and the reduction of power consumption of the communication apparatus at the same time.

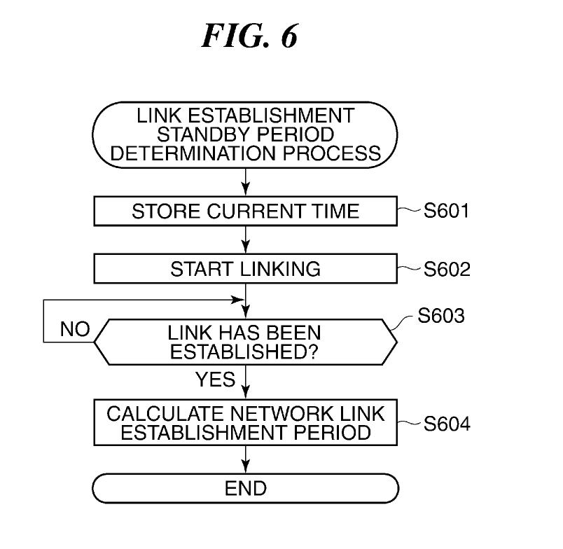

FIG. 6 is a flowchart of a link establishment standby period determination process executed by the CPU 201 appearing in FIG. 2.

The link establishment standby period determination process in FIG. 6 is realized by the CPU 201 of the main controller 101 controlling the LAN interface 208 according to a program stored in the ROM 203.

Referring to FIG. 6, the CPU 201 acquires a current time from the RTC 225 and stores the acquired time in the RAM 202 (step S601). Then, the LAN interface 208 starts linking with a PC 105 connected to the image processing apparatus 100 via the LAN 106, under the control of the CPU 201 (step S602).

Then, the PHY 310 detects whether or not the link has been established (step S603), and the CPU 201 waits until the network link with the PC 105 is established. When the link is established (YES to the step S603), the CPU 201 calculates a link establishment time period (step S604), followed by terminating the present process.

Specifically, in the step S604, the CPU 201 acquires a current time from the RTC 225 and calculates the link establishment standby period 403 as a time period required for establishment of the network link, based on the acquired time and the time stored in the RAM 202 in the step S601.

The link establishment standby period determination process eliminates the need to unconditionally store the link establishment standby period in advance in the ROM 203 of the main controller 101. Further, this process makes it possible to determine a link establishment standby period which is dependent on the network environment, based on the network environment of the image processing apparatus 100.

This enables calculation of a power-saving mode period turning point for changing the link speed according to the network environment, so that more effective reduction of power consumption can be achieved.

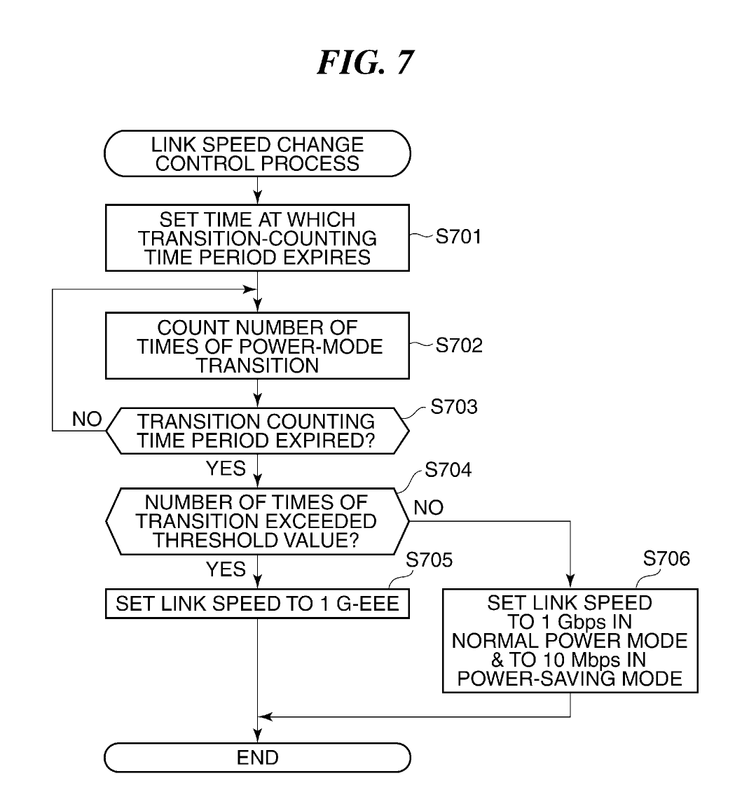

FIG. 7 is a flowchart of a variation of the link speed change control process executed by the CPU 201 appearing in FIG. 2.

The link speed change control process in FIG. 7 is realized by the CPU 201 of the main controller 101 executing a program stored in the ROM 203 and the micro processor 308 of the LAN interface 208 executing a program stored in the flash memory 302.

Referring to FIG. 7, the CPU 201 acquires a current time from the RTC 225 and sets a time at which expires a predetermined time period during which a cumulative total of the number of times of power-mode transition of the image processing apparatus 100 is counted (hereinafter referred to as “the transition-counting time period”) (step S701).

Then, the microprocessor 308 acquires the time at which expires the transition counting time period, via the system bus 207, and stores the acquired time in the RAM 311. The transition counting time period is variable, and a value stored in advance in the ROM 203 of the main controller 101 or a value input by a user via the console section 102 is set as the transition counting time period, for example.

Then, the microprocessor 308 counts a cumulative total of the number of times of transition of the image processing apparatus 100 between the normal power mode and the power-saving mode (step S702).

Then, the microprocessor 308 acquires the current time from the RTC 225, and if the transition counting time period has elapsed from the time set in the step S701 (YES to a step S703), it is determined whether or not the number of times of transition has exceeded a threshold value (step S704).

Specifically, it is determined whether or not the number of times of power-mode transition of the image processing apparatus 100 counted by the microprocessor 308 in the step S702 has exceeded the threshold value for determining the power-saving mode period turning point for changing the link speed.

The threshold value is a setting stored in advance e.g. in the flash memory 302 of the LAN interface 208, and the value is set in advance. The threshold value is set based on the standby-period electric power consumed during a standby period, the first electric power consumed during communication performed at 10 Mbps by the first link unit, and the second electric power consumed during communication performed at 1 Gbps by the second link unit are used. Therefore, this threshold value corresponds to a piece of switching information for switching between a communication by the first link unit and a communication by the second link unit such that one of the communications which consumes less electric power is selected.

If it is determined in the step S704 that the number of times of transition has exceeded the threshold value (YES to the step S704), the microprocessor 308 sets the network link speed of the LAN interface 208 to 1 G-EEE irrespective of the power mode of the image processing apparatus 100 as shown in FIG. 4B (step S705), followed by terminating the present process.

On the other hand, if the number of times of transition has not exceeded the threshold value (NO to the step S704), the microprocessor 308 sets the network link speed of the LAN interface 208 to 1 Gbps in the normal power mode and to 10 Mbps in the power-saving mode as shown in FIG. 4A (step S706), followed by terminating the present process.

The above-described link speed change control process makes it possible to reduce power consumption based on the number of times of power-mode transition of the image processing apparatus 100 within a predetermined time period. Further, since the processing in the steps S701 et seq. is executed by the microprocessor 308, the link speed change control process can be executed even when the image processing apparatus 100 is in the power-saving mode.

In the step S705 or 5706, when a predetermined condition is satisfied, switching between a communication by the first link unit and a communication by the second link unit is performed using the set switching information, such that one of the communications which consumes less electric power is selected. Therefore, the steps S705 and S706 correspond to the function of the switching unit.

The predetermined condition is the elapse of the predetermined time period (transition counting time period), and the switching information includes information indicative of the number of times of transition of the image processing apparatus 100 between the normal power mode and the power-saving mode.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2011-285963 filed Dec. 27, 2011, which is hereby incorporated by reference herein in its entirety.

What is claimed is:

1. A communication apparatus comprising:
a control unit configured to control the communication apparatus;
a communication unit configured to communicate with an external device via a network;
a power supply unit configured to, in a normal power state, supply power to said control unit and said communication unit, and in a power saving state, supply power to said communication unit, but not supply power to said control unit; and
a determination unit configured to determine in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate,
wherein said determination unit determines in which of the first communication mode and the second communication mode the communication apparatus is to be caused to operate, based on the number of times of transition between the normal power state and the power saving state.

2. The communication apparatus according to claim 1, wherein the determination unit in which of the first communication mode and the second communication mode the communication apparatus is to be caused to operate, based on the number of times of transition between the normal power state and the power saving state, occurring within a predetermined time period.

3. The communication apparatus according to claim 2, wherein said determination unit determines the communication apparatus is caused to operate in the first communication mode, when the number of times of transition between the normal power state and the power saving state exceeds a threshold value.

4. The communication apparatus according to claim 1, wherein the communication speed in the normal power state and the communication speed in the power saving state in the second communication mode are a communication speed selected from a plurality of communication speeds corresponding to Ethernet (registered trademark).

5. The communication apparatus according to claim 1, wherein the second communication mode is a mode corresponding to EEE (Energy Efficient Ethernet (registered trademark).

6. The communication apparatus according to claim 1, wherein said power supply unit supplies power to said control unit, when said communication unit receives from the external device packet data satisfying a condition for transition from the power saving state to the normal power state.

7. The communication apparatus according to claim 1, wherein said power supply unit supplies power to said determination unit in the normal power state, but does not supply power to said determination unit in the power saving state

8. The communication apparatus according to claim 1, wherein said communication unit disconnects a communication link with the external device in order to change the communication speed, when transition is to be performed from the power saving state to the normal power state, and said determination unit determines that the communication apparatus is to be caused to operate in the second communication speed.

9. A method of controlling a communication apparatus including a control unit configured to control the communication apparatus, and a communication unit configured to communicate with an external device via a network, comprising:
supplying, in a normal power state, power to the control unit and the communication unit, and in a power saving state, supplying power to the communication unit, but not supplying power to the control unit; and
determining in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate, based on the number of times of transition between the normal power state and the power saving state.

10. A non-transitory computer-readable storage medium storing a computer-executable program for causing a computer to execute a method of controlling a communication apparatus including a control unit configured to control the communication apparatus, and a communication unit configured to communicate with an external device via a network,
wherein the method comprises:
supplying, in a normal power state, power to the control unit and the communication unit, and in a power saving state, supplying power to the communication unit, but not supplying power to the control unit; and
determining in which of a first communication mode in which even in the power saving state, the communication apparatus communicates with the external device at a same communication speed as in the normal power state, and a second communication mode in which in the power saving state, the communication apparatus communicates with the external device at a lower communication speed than in the normal power state, the communication apparatus is to be caused to operate, based on the number of times of transition between the normal power state and the power saving state.
